(19) United States
(12) Patent Application Publication
(10) Pub. No.: US 2011/0318844 A1
(43) Pub. Date: Dec. 29, 2011

(54) System and Method for Determining Base Content of a Hydrophobic Fluid

(76) Inventors: Frederik R. van de Voort, Dollard des Ormeaux (CA); David Pinchuk, Montreal West (CA)

(21) Appl. No.: 13/171,566

(22) Filed: Jun. 29, 2011

Related U.S. Application Data
(60) Provisional application No. 61/359,553, filed on Jun. 29, 2010.

(51) Int. Cl. G01N 31/16

(52) U.S. Cl. 436/163

(57) ABSTRACT

A system and method of quantitatively characterizing base content of a hydrophobic fluid. The method includes providing a base neutralizing solution including an alcohol (preferably selected from the group consisting of 1-propanol, ethanol, methanol, and mixtures thereof), and mixing the solution with known amounts of a base to produce a number of calibration mixtures. Infrared spectroscopic testing is performed on the calibration mixtures to derive corresponding spectrum data. The spectrum data is processed to solve for a calibration equation that relates a spectral property measurable at a predetermined wavelength to a measure of base concentration per unit volume. The base neutralizing solution is also mixed with the hydrophobic fluid to produce a sample-extract. Infrared spectroscopic testing is performed on the sample-extract to derive corresponding spectrum data. The spectrum data for the sample-extract is processed to measure the spectral property of the calibration equation. The measured spectral property of the sample-extract is input to the calibration equation in order to output a measure of base concentration per unit volume for the sample-extract. A measure of base content of the hydrophobic fluid can be derived from the base concentration per unit volume for the sample-extract. The measure of base content of the hydrophobic fluid sample is derived without splitting of the hydrophobic fluid sample. The system includes a cell for holding and evaluating an extracted sample, an infrared spectrometer for measuring infrared absorption characteristics of the extracted samples, a computer equipped with software for analyzing data outputted by the infrared spectrometer.

### CROSS-REFERENCE TO RELATED APPLICATIONS

The present application claims priority from U.S. Provisional Pat. Appl. No. 61/359,553, entitled “System and Method for Determining Base Content in Generally Hydrophobic Products,” filed on Jun. 29, 2010, herein incorporated by reference in its entirety.

### BACKGROUND OF THE INVENTION

1. Field of the Invention

This invention relates broadly to a system and method for compositional analysis of generally hydrophobic fluids (such as lubricants, edible oils, and fuels such as biodiesel). More particularly, the invention relates to systems and methods for determining the base content of such fluids using infrared spectroscopy, in particular with Fourier Transform Infrared (FTIR) spectroscopy.

2. State of the Art

Infrared (IR) spectroscopy is the subset of spectroscopy that deals with the infrared region (e.g., typically including wavelengths from 0.78 to approximately 300 microns) of the electromagnetic spectrum. It covers a range of techniques, the most common being a form of absorption spectroscopy. As with all spectroscopic techniques, it can be used to identify compounds or investigate sample composition. A common laboratory instrument that uses this technique is an infrared spectrophotometer. Infrared spectroscopy exploits the fact that molecules have discrete rotational and vibrational energy levels and absorb infrared light at specific frequencies that are determined by the differences in energy between these discrete energy levels.

In IR absorption spectroscopy, the infrared spectrum of a sample is recorded by passing a beam of infrared light through the sample or placing the sample on the surface of an internal reflection element through which a beam of infrared light is passed by total internal reflection. Measurement of the transmitted or totally internally reflected light striking a detector reveals how much energy was absorbed at each wavelength. This can be done with a monochromatic beam, which changes in wavelength over time. Alternatively, a polychromatic IR beam (e.g., a range of IR wavelengths) can be passed through the sample to measure a range of wavelengths at once. From this, a transmittance or absorbance spectrum (referred to herein as a “spectrum”) is produced, showing the IR wavelengths at which the sample absorbs. Analysis of the absorption spectrum for the sample reveals details about the molecular structure of the sample.

Fourier Transform Infrared (FTIR) spectroscopy is a form of IR absorption spectroscopy that utilizes an interferometer placed between a polychromatic source of IR light and the sample. Measurement of the light striking the detector produces an interferogram. Performing a Fourier transform on the interferogram shows the IR wavelengths at which the sample absorbs. The development of FTIR technology has substantially enhanced the utility and sensitivity of IR spectroscopy as a tool for quantitative analysis. In addition, various data analysis techniques have been developed to facilitate accurate quantitative analysis of highly complex sample mixtures subjected to IR spectroscopic examination. The information inherent in the absorption spectrum of such sample mixtures includes information at the molecular level about the chemical composition of the mixture. Thus, FTIR technology and analysis allows for the determination of the concentrations of the components in the sample mixture, and for the detection of contaminants or other unwanted chemical components or compounds in the sample mixture.

One area in which FTIR spectroscopy has been extensively utilized is in the monitoring of the condition of lubricating fluids, an activity which has commonly been performed in commercial laboratories. For example, FTIR spectroscopy has been employed to monitor the levels of additives present in such fluids and of degradation products that may be generated as a result of breakdown of the fluid. In another example described by Jun Dong, Frederick R. van de Voort, Varoujan Yaylayan and Ashraf A. Ismail in “Determination of Total Base Number (TBN) in Lubricating Oils by Mid-TFIR Spectroscopy,” Society of Tribologists and Lubrication Engineers, March 2009, the total base number (TBN) of a lubricating oil sample is quantified by an FTIR method that employs calibration standards with TBN values of 0-20 mg KOH/g prepared by adding barium dinonylnaphthalene sulfonate (BaDNS) concentrate to an additive-free polyalphaolefin (PAO) base oil. The calibration standards are subject to FTIR spectrum scanning The absorbance at 1672 cm⁻¹ relative to the absorbance at 2110 cm⁻¹ for each calibration standard is fit to calculated TBN values to derive a calibration equation that relates absorbance at 1672 cm⁻¹ relative to the absorbance at 2110 cm⁻¹ to a TBN value. The lubricating oil sample is split into two parts. One of the two sample parts is subject to FTIR spectrum scanning 0.5 grams of the second part is added to 5 mL of a TFA reactant solution, and the resulting mixture is subject to FTIR spectrum scanning A differential spectrum is derived from the two FTIR spectrums. The absorbance of the differential spectrum at 1672 cm⁻¹ relative to the absorbance at 2110 cm⁻¹ is input to the calibration equation to derive TBN for the sample. This FTIR method was an improvement over the ASTM titration methodology, a methodology commonly used to measure total base number in oil samples. This method is limited to mineral oils and requires two analyses to obtain a single result, thus involving more sample preparation and handling.

### SUMMARY OF THE INVENTION

The present invention is directed to a system and method for generating data characterizing the base content (e.g., concentration of base) in a fluid sample which is predominantly hydrophobic in nature. The method includes mixing the hydrophobic fluid of interest with a base-neutralizing solution and deriving a measure of base content of the hydrophobic fluid of interest from a spectral property derived from IR spectroscopy of the resultant solution. The base-neutralizing agent solution may be prepared in an alcohol (preferably selected from the group consisting of 1-propanol, ethanol, methanol, and combinations thereof). An alcohol is an organic compound in which a hydroxyl functional group (—OH) is bound to a carbon atom. In the preferred embodiment, the spectral property is defined by data within a predetermined wavelength in the spectral region between 1666 cm⁻¹ and 1686 cm⁻¹ (most preferably at or near the absorption band of the trifluoroacetate anion at 1676 cm⁻¹). The system includes an infrared spectrometer, a cell for holding and evaluating a sample, and a computer or workstation equipped with data analysis software for analyzing the data measured by the infrared spectrometer. The system can also include equipment for facilitating manual and/or automated operation of the infrared spectrometer, sample testing, and data collection.

As part of a calibration process, the infrared spectrometer and the data analysis software executing at the workstation are used to perform IR spectroscopy on the agent solution itself and on a number of calibration mixtures prepared with the base-neutralizing agent solution and known amounts of base. In the preferred embodiment, the concentrations of the base-neutralizing agent solution and the base of the respective calibration mixtures is controlled such that the base-neutralizing solution neutralizes the base of the respective calibration mixture and thus the base concentration of the respective calibration mixture is at or near zero. The spectrum of the agent solution is used in conjunction with the respective spectrum for the number of calibration mixtures to derive differential spectrums for the number of calibration mixtures. The differential spectrums for the number of calibration mixtures are processed to derive corresponding final spectrums for the number of calibration mixtures. Preferably, such processing involves taking the second derivative (most preferably the 5-5 (gap-segment) second derivative) of the respective differential spectrum to derive the corresponding final spectrum. Spectral properties of the final spectrums, preferably in the spectral range between 1666 cm⁻¹ and 1686 cm⁻¹ (most preferably at or near 1676 cm⁻¹), are used to solve for parameters of a calibration equation that relates the spectral property to a measure of base concentration per unit volume (such as mEq base/mL).

In order to characterize the base content of a hydrophobic fluid, the infrared spectrometer and the data analysis software executing at the workstation are used to perform IR spectroscopy on a sample-extract produced by mixing the base neutralizing solution with the hydrophobic fluid of interest and possibly other compounds (such as heptane, cyclohexane, toluene or trichloroethylene). The spectrum of the agent solution itself (measured during the calibration process) is used in conjunction with the spectrum of the sample-extract to derive a differential spectrum for the sample-extract. The differential spectrum for the sample-extract is processed to derive a final spectrum for the sample-extract in a manner that mirrors the differential spectrum processing of the calibration process. Preferably, such processing involves taking the second derivative (most preferably the 5-5 (gap-segment) second derivative) of the differential spectrum to derive the final spectrum of the sample-extract. A spectral property of the final spectrum of the sample-extract, preferably in the spectral range between 1666 cm⁻¹ and 1686 cm⁻¹ (most preferably at or near 1676 cm⁻¹), is input to the calibration equation derived by the calibration process, which outputs a measure of base concentration per unit volume (such as mEq base/mL) that reflects the base content of the sample extract. A measure of base content of the hydrophobic fluid of interest is derived from the measure of base concentration per unit volume of the sample-extract.

Alcohols (particularly 1-propanol, methanol and ethanol) are suitable for use as the solvent in the base neutralizing agent solution because they are largely immiscible with most hydrophobic samples and do not absorb strongly in the regions of the mid-IR spectrum where the trifluoroacetate anion (formed when bases present in the sample are neutralized by the base neutralizing agent neutralization) absorbs, thus allowing for low levels of base to be detected through measurement of the absorption of the trifluoroacetate anion.

In the preferred embodiment of the invention, dilution of the base neutralizing agent by the hydrophobic fluid dissolved in it can be compensated for by calculating a dilution correction factor (DCF) for the spectrums of the calibration mixtures employed during calibration and the sample-extract. More particularly, the DCF is calculated by dividing the height of a predetermined spectral band (preferably at or near 1936cm⁻¹ for 1-propanol) relative to a baseline band (preferably at or near 1859 cm⁻¹) for the spectrum of the agent solution itself by the height of the particular spectral band relative to the baseline for the spectrum of the respective calibration mixture or sample-extract. The respective spectrum is multiplied by the corresponding DCF to provide a corrected spectrum. The spectrum of the agent solution itself is subtracted from the corrected spectrums to derive differential spectrums for the calibration mixtures employed during calibration and the sample-extract as required.

Advantageously, the present method characterizes the base content of a generally hydrophobic sample. As further discussed below, by neutralizing base compounds present in the sample with an agent solution, spectral interferences from the sample during FTIR analysis are minimized. Moreover, the approach of the present invention provides a measure of base content of the hydrophobic fluid sample without splitting of the hydrophobic fluid sample, which can provide substantial gains in sample analytical throughput for a given system.

The method of the invention also provides significant flexibility to modify the analytical range and sensitivity of the calibration and/or analyses by simple adjustment of the calibration, sample weights, reagent volumes, or combinations thereof.

Additional objects and advantages of the invention will become apparent to those skilled in the art upon reference to the detailed description taken in conjunction with the provided figures.

### BRIEF DESCRIPTION OF THE DRAWINGS

FIG. 1 is a schematic view of a system for performing FTIR spectroscopy that can embody the present invention.

FIGS. 2A and 2B, collectively, is a flowchart showing the workflow for characterizing base content of a fluid sample in accordance with the present invention.

FIG. 3 is a flowchart showing operations for calculating a differential spectrum that can be used in conjunction with the workflow of FIGS. 2A and 2B; the differential spectrum generated by the operations of FIG. 3 compensates for dilution of the base neutralizing agent by the hydrophobic fluid dissolved in it.

### DETAILED DESCRIPTION OF THE PREFERRED EMBODIMENTS

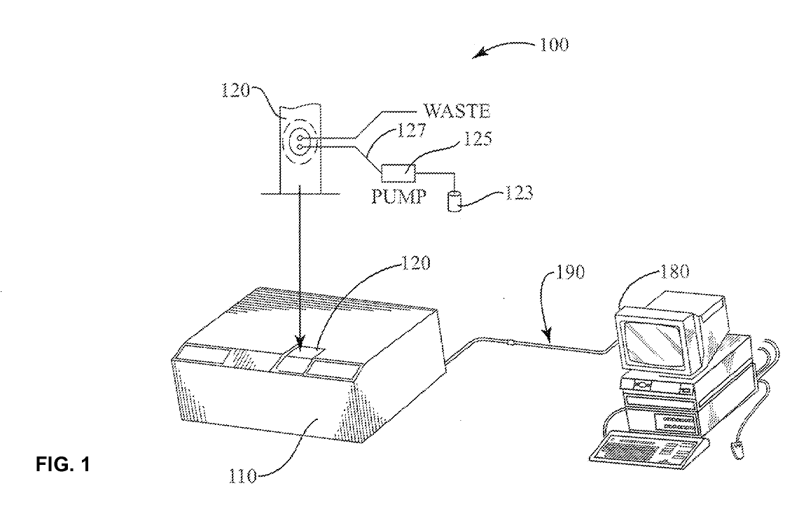

Turning to FIG. 1, a system 100 for performing spectroscopic analysis of a sample includes a spectrometer 110 for collecting IR absorption data. The spectrometer 110 can be realized by a WorkIR series IR spectrometer, which is preferably equipped with a deuterated triglycine sulfate (DTGS) detector as sold commercially by ABB Analytical of Quebec, Canada. Other commercially-available IR spectrometers can also be used. A flow-through sample cell 120 is provided into which fluids from a sample vial may be loaded manually, such as by vacuum aspiration into the cell 120. Alternatively, the fluid sample may be loaded into the sample cell 120 in an automated manner, for example with a minipump used in conjunction with an autosampler (not shown). In the preferred embodiment, the sample cell 120 is realized by a 100-μm CaF₂ transmission flow cell. Data acquired by the spectrometer 110 is communicated to a computer or workstation 180 via a data interface 190 (e.g., USB data interface or the like) for processing and analysis in accordance with the present invention. The computer 180 preferably includes a complete and fully integrated software package which is run at the computer 180 for analyzing the data and outputting information to a user (e.g., via a printer and/or on-screen). The software should at a minimum be able to perform acquisition of IR spectral data measured by the spectrometer 110 as well as Fourier transform analysis and quantification of such IR spectral data.

In the preferred embodiment, the spectral acquisition parameters for the apparatus 100 are set to the following:
resolution—4 cm⁻¹;
apodization—triangular;
gain—1;
spectral acquisition time—approximately 32 seconds; and
number of co-added scans—32 or 16, depending on whether the spectrometer 110 collects single-sided or double-sided interferograms).

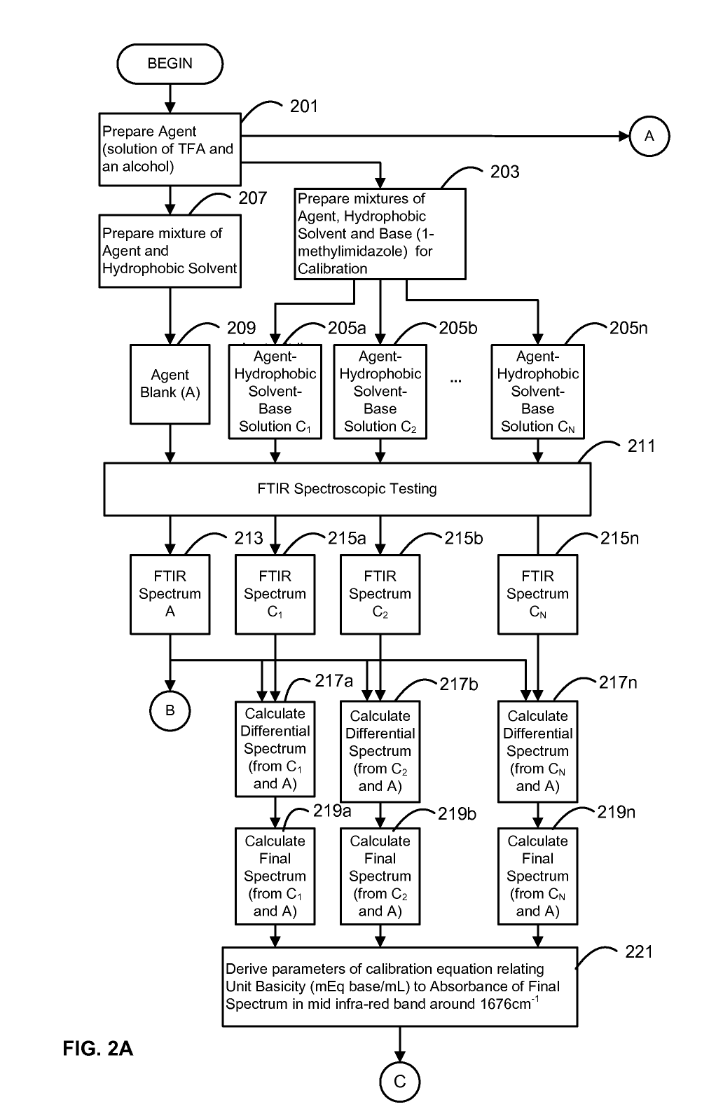

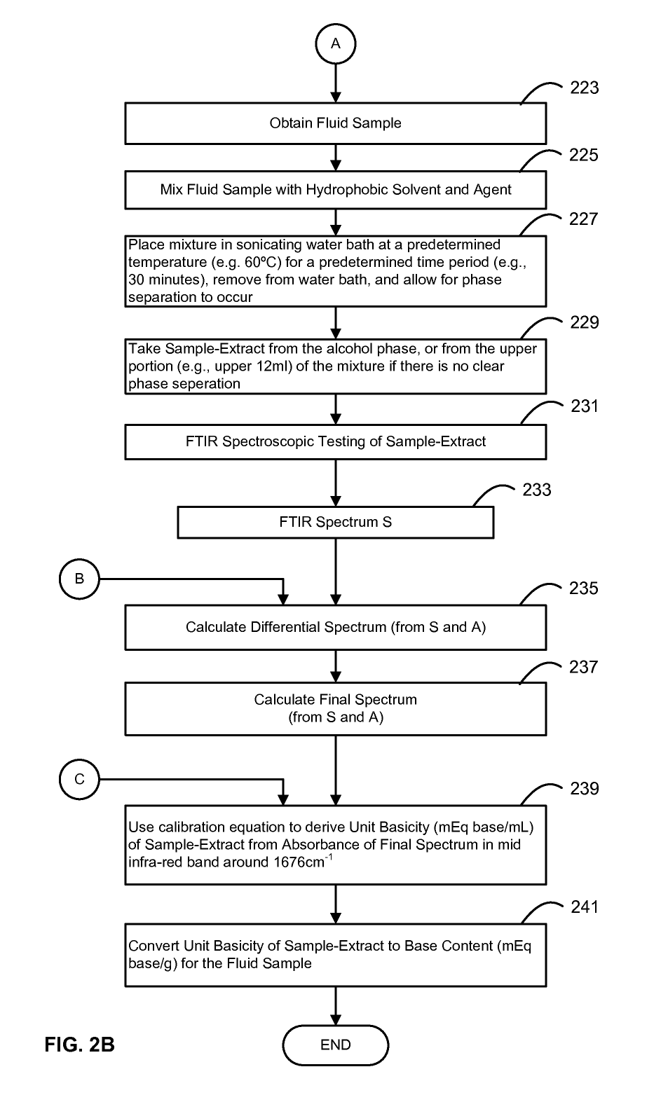

The system 100 of FIG. 1 is used to perform the methodology 200 of FIGS. 2A and 2B for generating data characterizing the base content of a generally hydrophobic fluid sample in accordance with the present invention. The method begins at block 201 with the preparation of a base neutralizing agent. In the preferred embodiment, the base neutralizing agent is realized from a mixture of an acid (more preferably trifluoroacetic acid (TFA, C₂HF₃O₂)) and anhydrous 1-propanol (C₃H₈O). For example, the agent can be realized by weighing out 50 grams of TFA and adding it to one liter volume of anhydrous 1-propanol. There is no need to accurately weigh out the quantity of TFA as all spectral measurements used for calibration and sample analysis in this test method are made relative to an agent blank and hence are independent of the concentration of TFA in the agent solution.

The concentration of TFA in the agent solution defines the overall base neutralizing capacity of the agent solution. First, the moles of TFA in the agent solution can be derived as:

$$\begin{matrix}Moles of T F A = ( \frac{weight T F A ( in gram )}{molecular weight of T F A ( in grams \text{/} mol )} ) \\ = \frac{50 g}{\frac{114.02 g}{mole}} \\ = 0.4385 mol of T F A\end{matrix} \qquad ( 1 )$$

Second, the base neutralizing capacity of the agent solution can be expressed in units of milliequivalent base per unit volume as:

$$\begin{matrix}\frac{mEq base}{mL} = ( {10}^{3} mEq base \text{/} mole ) * \\ ( mole T F A \text{/} L ( from ( 1 ) ) * ( {10}^{- 3} L \text{/} mL ) \\ = 0.4385 mEq base \text{/} mL\end{matrix} \qquad ( 2 )$$

Alternatively, the base neutralizing capacity of the agent solution can be expressed in units of mass KOH per unit volume as:

$$\begin{matrix}mg K O H \text{/} mL = mole T F A \text{/} L ( from ( 1 ) ) * \\ molecular weight of K O H ( in g \text{/} mole ) \\ = 0.4385 mol T F A \text{/} L * 56.11 g \text{/} mol \\ = 24.6 g K O H \text{/} L \\ = 24.6 mg K O H \text{/} mL\end{matrix} \qquad ( 3 )$$

The TFA and 1-propanol of the agent solution can be purchased from Sigma-Aldrich of Oakville, Ontario, Canada. The absorbance of the freshly prepared agent solution is unstable as TFA is esterified by 1-propanol over time. Thus, it is important to “age” the agent solution, preferably for 48 hours. Sufficient “aging” can be verified by measuring the absorbance of the agent solution at two wavelengths. The first absorbance measure can be derived at a wavelength of 1787 cm⁻¹ relative to a baseline at 1860 cm⁻¹. The second absorbance measure can be derived at a wavelength of 1740 cm⁻¹ relative to the baseline at 1860 cm⁻¹. A ratio of the first absorbance measure relative to the second absorbance measure can be determined. If this ratio is greater than seven, the solution is sufficiently aged. The solution can be transferred to a propipette for dispensing.

Other alcohols (particularly ethanol (C₂H₆O) and methanol (CH₃OH)) can be used as the solvent in the base neutralizing agent solution because they are largely immiscible with most hydrophobic samples and do not absorb strongly in the regions of the mid-IR spectrum where the trifluoroacetate anion (formed when bases present in the sample are neutralized by the base neutralizing agent neutralization) absorbs, thus allowing for low levels of base to be detected through measurement of the absorption of the trifluoroacetate anion.

Other acids can be used to as part of the base neutralizing agent solution. For example, other fluorinated, chlorinated or brominated carboxylic acids with a pKₐ in the range of 0.5-1.5 may also serve to neutralize the bases. In this case, the calibration equations and sample spectral analysis can correlate a spectral property in a spectral range at or near a carboxylate absorption band of the respective fluorinated, chlorinated or brominated carboxylate anion to a measure of base concentration per unit volume (such as mEq base/mL).

At block 203, the agent solution of block 201 is mixed with heptane (C₇H₁₆) and a base at different base concentration levels to produce a number of calibration mixtures C₁, C₂, . . . C_{N} (labeled 205A, 205B . . . 205N) for calibration purposes. The calibration mixtures C₁, C₂, . . . C_{N} are preferably stored in a suitable glass vial. In the preferred embodiment, the base of the calibration mixtures is 1-methylimidazole (C₄H₆N₂), which can be purchased from Sigma-Aldrich of Oakville, Ontario, Canada. In an illustrative embodiment, the calibration mixtures 205A, 205B . . . 205N are prepared by weighing out predetermined quantities of the base (for example, 10, 20, 40, 60, 80 and 100 mg of 1-methylimidazole) into each of six glass vials on an analytical balance and record the weights. A predetermined quantity (e.g., 15 mL) of the agent solution of block 201 is added to each vial, for example using a propipette. Furthermore, a predetermined quantity (e.g., 4.5 ml) of heptane is also added to each vial. The resulting solution is mixed in the vial preferably by a vortex mixer. The vials should be sealed to prevent ingress of atmospheric moisture and carbon dioxide (which may react with the TFA of the agent solution). A cap fitted with a Mylar liner provides a good seal and facilitates sample analysis. For the case where ethanol or methanol is used as the solvent of the base neutralizing agent, phase separation will occur, with the ethanol or methanol phase being the lower layer, and it may be preferable to use a higher density solvent such as toluene, cyclohexane or trichloroethylene in place of heptane, such that the ethanol or methanol phase constitutes the upper layer.

Bases other than 1-methylimidazole (e.g., dodecylamine and other aliphatic amines or aromatic amines) may be used as part of the calibration mixtures to perform the calibration function.

The concentrations of the base-neutralizing agent solution and the base of the respective calibration mixtures is controlled such that the base-neutralizing solution neutralizes the base of the respective calibration mixture and thus the base concentration of the respective calibration mixture is at or near zero.

The concentration of the base (e.g., 1-methylimidazole) in each calibration mixture can be expressed as mEq base/mL and termed Unit Basicity (UB). In the preferred embodiment, the UB value for each respective calibration mixture C₁, C₂, . . . C_{N} (labeled 205A, 205B . . . 205N) is derived as:

UB=W/((V)*(MI)) (4)

UB=Unit Basicity (mEq of base/mL) for the respective calibration mixture;

W=weight (mg) of the base (1-methylimidazole) for the respective calibration mixture;

V=volume (in mL) of the agent solution and solvent (e.g., heptane) added to the base (1-methylimidazole);

MI=molecular weight (g/mole) of the base, for example 82.11 g/mol for 1-methylimidazole.

This measure of base concentration termed Unit Basicity is universal in that it is independent of the sample weight and the agent volume used in the analysis of samples.

In block 207, the agent solution of block 201 is mixed with heptane (C₇H₁₆) to produce an agent blank (labeled 209). In an illustrative embodiment, the agent blank 209 is prepared by adding a predetermined quantity (e.g., 15 mL) of the agent solution of block 201 and a predetermined quantity (e.g., 4.5 ml) of heptane to a vial. The resulting solution is mixed in the vial preferably by a vortex mixer. The vial should be sealed to prevent ingress of atmospheric moisture and carbon dioxide (which may react with the TFA of the agent solution). A cap fitted with a Mylar liner provides a good seal and facilitates sample analysis.

In block 211, the system 100 is used to perform FTIR spectroscopic analysis on the agent blank A (labeled A) as well as on each one of the calibration mixtures C₁, C₂ . . . C_{N}. The FTIR spectroscopic analysis of the agent blank A produces an FTIR spectrum A (labeled 213) at the computer 180. The FTIR spectroscopic testing of the calibration mixture C₁ produces an FTIR spectrum C₁ (labeled 215A) at the computer 180. The FTIR spectroscopic testing of the calibration mixture C₂ produces an FTIR spectrum C₂ (labeled 215B) at the computer 180. FTIR spectrums are generated for all of the remaining calibration mixtures C₃ . . . C_{N} by the computer 180. In the preferred embodiment, a set-up procedure is performed as part of the analysis of each sample. The set-up procedure typically involves cleaning the sample cell of the spectrometer 110 (for example, by washing with a solvent and drying by forcing air through the sample cell), performing a background scan on the spectrometer 110, loading the fluid sample into the sample cell of the spectrometer 110, and configuring the operating parameters for the spectrometer 110 and computer 180. After the set-up procedure is complete, the spectrometer 110 and computer 180 are operated to perform the experiment, collect the IR absorption data resulting from the experiment, and perform Fourier Transform processing on the collected IR absorption data to generate the FTIR spectrum for the respective sample.

In block 217A, the computer 180 calculates a differential spectrum for the calibration mixture C₁ from the FTIR spectrum C₁ (labeled 215A) and the FTIR spectrum A (labeled 213). In block 217B, the computer 180 calculates a differential spectrum for the calibration mixture C₂ from the FTIR spectrum C₂ (labeled 215B) and the FTIR spectrum A (labeled 213). Similar operations are performed by the computer 180 in blocks 217C . . . 217N to calculate differential spectrums for the calibration mixtures C₃ . . . C_{N}. Details of preferred spectral processing in deriving the differential spectrums of block 217A . . . 217N are described below with respect to FIG. 4. This preferred spectral processing compensates for miscibility of the fluid sample and an agent solution of 1-propanol. Alternatively, other suitable spectral processing can be used.

In block 219A, the computer 180 processes the differential spectrum of block 217A to calculate a final spectrum for the calibration mixture C₁. In block 219B, the computer 180 processes the differential spectrum of block 217B to calculate a final spectrum for the calibration mixture C₂. Similar operations are performed by the computer 180 in blocks 219C . . . 219N to calculate final spectrums for the calibration mixtures C₃ . . . C_{N}. In the preferred embodiment, the final spectrum for the respective calibration mixture is derived by taking 5-5 (gap segment) second derivative of the corresponding differential spectrum and multiplying the resultant second derivative by 100. The gap-segment 2^{nd} derivative serves the purpose of providing a stable baseline to measure to, sharpens bands and helps separate any overlapping bands, which minimizes spectral interferences arising from any portion of the sample that is miscible with the 1-propanol or other alcohol used.

The 5-5 (gap-segment) second derivative of the differential spectrum for each respective calibration mixture is preferably computed as follows. First, the absorbance value A(i) at each data point i of the differential spectrum is replaced by the mean absorbance value for a segment of 5 data points centered at data point i by:

A(i)=[A(i−2)+A(i−1)+A(i)+A(i+1)+A(i+2)]/5 (5)

A gap second derivative is then applied at each data point i by:

d²A(i)/dx₂=[−2A(i)+A(i+2g)+A(i−2g)]/4gΔx (6)

where Δx is the data point spacing in units of wavenumbers, and
g is set to 5 for the 5-5 (gap-segment) second derivative.
   The result at each data point i is multiplied by 100 to produce the final spectrum. It is noted that measurements made on this second-derivative spectrum are referred to as absorbance (Abs) measurements for the sake of simplicity.

For example, the final spectrum for the calibration mixture C₁ is derived by taking 5-5 (gap segment) second derivative of the differential spectrum of block 217A as described above. Alternatively, other suitable spectral processing can be used. It may be noted that the spectral values output by blocks 219A . . . 219N may not be in absorbance units but are referred to as absorption measurements herein. It may also be noted that these measurements are not referenced to a spectral baseline point, because baseline offsets and tilts are not significant in second derivative spectra.

In block 221, the computer 180 utilizes the absorbance measurements of the final spectrums 219A, 219B . . . 219N in the spectral range between 1666 cm⁻¹ and 1686 cm⁻¹ (preferably at or near 1676 cm⁻¹) to derive parameters of a calibration equation relating Unit Basicity (in mEq of base/mL) to absorbance of the final spectrum in this particular spectral range. In the preferred embodiment, the computer 180 derives Unit Basicity for the calibration mixtures C₁ . . . C_{N} from the weight of the base (1-methylimidazole) for the respective calibration mixtures and the volume of the agent solution and heptane (or other solvent) added to the base (1-methylimidazole) as shown in Eq. (4) above.

The computer 180 can carry out linear regression on the Unit Basicity for the calibration mixtures and the absorbance of the final spectrums 219A, 219B . . . 219N for the particular spectral range to obtain the parameters (a, b) of a best fit equation of the form:

Unit Basicity (mEq of base/mL)=a+b*Abs_{(1676 cm}_{^{−1).}} (7)

Importantly, the calibration equation relating Unit Basicity to absorbance for the particular spectral band is universal in that it is independent of the sample weight or the agent volume used in the analysis of samples.

In block 223, a generally hydrophobic fluid sample is obtained. The hydrophobic fluid sample can be a lubricant, an edible oil, or a fuel such as biodiesel.

In block 225, at least a portion of the hydrophobic fluid of block 223 is mixed with heptane (or other hydrophobic solvent) and the agent solution of block 201 at or near a predetermined concentration. In the preferred embodiment, approximately 3 grams of the hydrophobic fluid of block 219 is first mixed with approximately 4.5 mL of heptane and the resulting mixture is then mixed with approximately 15 mL of the agent solution of block 201. The mixture is preferably stored in a suitable vial. The vial should be sealed to prevent ingress of atmospheric moisture and carbon dioxide (which may react with the TFA of the agent solution). A cap fitted with a Mylar liner provides a good seal and facilitates sample analysis. The weight (in grams) of the hydrophobic fluid of the mixture is measured and recorded by the computer 180. The volume (in mL) of the agent solution and heptane of the mixture is measured and recorded by the computer 180.

In block 227, the mixture of block 225 is agitated (for example, in a sonicating water bath) at a predetermined temperature (e.g., 60° C.) for a predetermined period of time (e.g., 30 minutes).

In block 229, after the mixing of block 227 is complete, the mixture is allowed to stand for a period of time (e.g., 10 minutes) to permit phase separation to occur. Alternatively, the mixture can be centrifuged to provide for phase separation. A sample-extract is then obtained by taking 12 mL from the alcohol phase. Where 1-propanol is used as the solvent of the base neutralizing agent, phase separation will not occur in some samples, in which case the upper 12 mL of the resultant alcohol/sample mixture is taken as the sample-extract.

In block 231, the system 100 is used to perform FTIR spectroscopic analysis on the sample-extract to produce an FTIR spectrum S (labeled 233). In the preferred embodiment, a set-up procedure is performed as part of the analysis of the sample-extract. The set-up procedure typically involves cleaning the sample cell of the spectrometer 110 (for example, by washing with a solvent and drying by forcing air through the sample cell), performing a background scan on the spectrometer 110, loading the sample-extract into the sample cell of the spectrometer 110, and configuring the operating parameters for the spectrometer 110 and computer 180. After the set-up procedure is complete, the spectrometer 110 and computer 180 are operated to perform the experiment, collect the IR absorption data resulting from the experiment, and perform Fourier Transform processing on the collected IR absorption data to generate the FTIR spectrum for the sample-extract.

In block 235, the computer 180 calculates a differential spectrum for the sample-extract from the FTIR spectrum S (labeled 233) and the FTIR spectrum A (labeled 213). Details of preferred spectral processing in deriving the differential spectrum of block 235 are described below with respect to FIG. 4. This preferred spectral processing compensates for differences in density between the agent solution and the sample-extract and for any miscibility of the fluid sample with the alcohol solvent used in preparing the agent solution (e.g., 1-propanol). Alternatively, other suitable spectral processing can be used.

In block 237, the computer 180 processes the differential spectrum of block 235 to calculate a final spectrum for the sample-extract. In the preferred embodiment, the final spectrum for the sample-extract is derived by taking 5-5 (gap segment) second derivative of the corresponding differential spectrum as described above. The gap-segment 2^{nd} derivative serves the purpose of providing a stable baseline to measure to, sharpens bands and helps separate any overlapping bands, which minimizes the spectral interferences that can arise from miscibility of the fluid sample with the alcohol solvent used in preparing the agent solution (e.g., 1-propanol). Alternatively, other suitable spectral processing can be used. It may be noted that the spectral values output by blocks 219A . . . 219N may not be in absorbance units but are referred to as absorption measurements herein. It may also be noted that these measurements are not referenced to a spectral baseline point, because baseline offsets and tilts are not significant in second derivative spectra.

In block 239, the computer 180 utilizes the absorbance measurements of the final spectrum of block 237 for the spectral band between 1666 cm⁻¹ and 1686 cm⁻¹ (preferably at or near 1676 cm¹) as an input to the calibration equation of block 221 to calculate Unit Basicity (in mEq of base/mL) of the sample-extract. Importantly, the calibration equation relating Unit Basicity to absorbance for the particular spectral band is universal in that it is independent of the sample weight or agent volume used in the analysis of samples.

In block 241, computer 180 converts the Unit Basicity (mEq of base/mL) of the sample-extract of block 239 to a measure of Base Content (preferably in mEq of base/g) in the fluid sample. In the preferred embodiment, the conversion of block 241 involves multiplying the Unit Basicity of the sample-extract as derived in block 239 by the ratio of the sum of the volumes (in mL) of agent solution and hydrophobic solvent used in forming the sample-extract in block 225 and the weight (in g) of sample used in forming the sample-extract in block 225. The Base Content (mEq of base/g) of the sample can be stored by the computer 180 and output to the user as desired.

The Base Content of the sample may also be converted to and expressed as mg KOH/g of sample, units which are normally associated with the determination of Base Number (BN), values analysts are more familiar with. BN values are not equivalent to Base Content values in absolute terms because the pKₐ values of the acids used for BN analysis are significantly lower than that of trifluoroacetic acid, but the Base Content results will generally correlate with BN.

Blocks 223-241 can be performed by automated (or semi-automated) fluid handling and measuring equipment as is well known in the art. Parts of blocks 223-241 can be performed by manual fluid handling and measuring operations as is well known in the art.

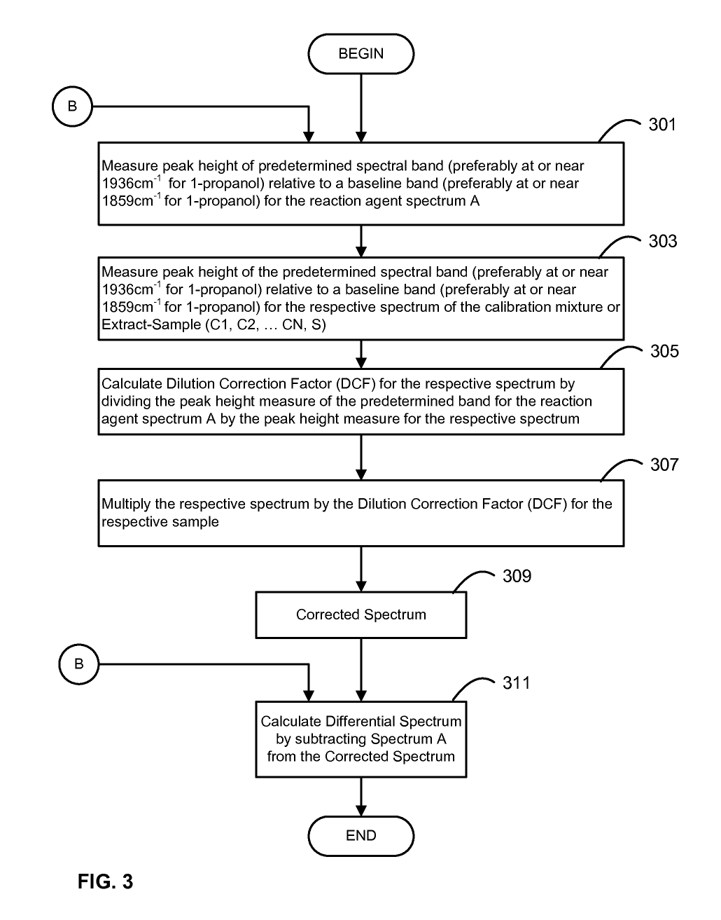

In an illustrative embodiment, the workflow of FIG. 2 generates differential spectrums in a manner that compensates for differences in density between the agent solution and the sample-extract and for any miscibility of the fluid sample with the alcohol solvent used in preparing the agent solution (e.g., 1-propanol). Details of preferred operations for generating such differential spectrums is shown in FIG. 3, which begins in block 301 where the computer 180 measures the peak height of a predetermined band (preferably at or near 1936 cm⁻¹ for 1-propanol solvent) relative to a predetermined baseline (preferably at or near 1859 cm⁻¹ for 1-propanol solvent) for the FTIR spectrum A of block 213.

In block 303, the computer 180 measures the peak height of the predetermined band (preferably at or near 1936 cm⁻¹ for 1-propanol solvent) relative to the predetermined baseline (preferably at or near 1859 cm⁻¹ for 1-propanol solvent) for the respective calibration mixture or sample-extract spectrum (C1, C2 . . . CN, or S).

In block 305, the computer 180 calculates a dilution correction factor (DCF) for the respective spectrum (C1, C2 . . . CN, or S) by dividing the peak height of block 301 by the peak height of block 303.

In block 307, the computer 180 multiplies the respective spectrum (C1, C2 . . . CN, or S) by the DCF of block 305 to derive a respective corrected spectrum 309.

In block 311, the computer 180 calculates a differential spectrum by subtracting the FTIR spectrum A of block 213 from the corrected spectrum 309. This differential spectrum compensates for differences in density between the agent solution and the sample-extract and for any miscibility of the fluid sample with the alcohol solvent used in preparing the agent solution (e.g., 1-propanol).

Advantageously, the present method characterizes the base content of a generally hydrophobic sample. As further discussed below, by neutralizing base compounds present in the sample with an agent solution, spectral interferences from the sample during FTIR analysis are minimized. Moreover, the approach of the present invention provides a measure of base content of the hydrophobic fluid sample without splitting of the hydrophobic fluid sample, which can provide substantial gains in sample analytical throughput for a given system.

There have been described and illustrated herein several embodiments of a system and a method of determining base content in hydrophobic fluid such as lubricants, edible oils, and fuels using a base neutralizing solution of an alcohol (preferably selected from the group consisting of 1-propanol, ethanol, methanol, and combinations thereof) to characterize base content and compensating for matrix effects stemming from miscibility of the hydrophobic fluid in the base neutralizing solution. While particular embodiments of the invention have been described, it is not intended that the invention be limited thereto, as it is intended that the invention be as broad in scope as the art will allow and that the specification be read likewise. Thus, while particular instruments and apparatuses have been disclosed, it will be appreciated that other instruments and apparatuses may be used as well, including various types of computers, spectroscopic analyzers, and manual or automated systems to conduct sample testing to control and/or monitor the quality of a fluid. In addition, while particular quantities and volumes of reagents and samples have been disclosed, it will be appreciated that other quantities and volumes of reagents and samples may be used. While particular method steps for procuring and testing samples have been disclosed, it will be appreciated that certain steps may be omitted from the method, and/or that other steps may be included in the method. Further, while a particular calibration process has been disclosed, it will be appreciated that other calibration processes and empirical modules relating measured absorption changes at the IR wavelengths related to base content or compensation for underlying absorptions may be utilized. While particular attributes of a sample have been measured and particular equations and calculations have been disclosed based on the measured attributes of the sample for calculating specific parameters of the sample, it will be appreciated that other equations may be utilized, other attributes may be measured, and other parameters may be calculated. It will therefore be appreciated by those skilled in the art that yet other modifications could be made to the provided invention without deviating from its spirit and scope as claimed.

What is claimed is:

1. A method of characterizing base content of a hydrophobic fluid sample, comprising:
i) providing a base neutralizing solution including an alcohol solvent;
ii) mixing the solution of i) with known amounts of a base to produce a number of mixtures;
iii) performing infrared spectroscopic testing of the number of mixtures of ii) to derive spectrum data for the number of mixtures;
iv) processing the spectrum data for the number of mixtures to solve for a calibration equation that relates a spectral property measurable at a predetermined wavelength to a measure of base concentration per unit volume;
v) mixing the solution of i) with at least a portion of the hydrophobic fluid sample to produce an sample-extract;
vi) performing infrared spectroscopic testing of the sample-extract to derive spectrum data for the sample-extract;
vii) processing the spectrum data for the sample-extract to measure the spectral property of the calibration equation of iv);
viii) using the measure of the spectral property of vii) as input to the calibration equation derived in iv) in order to output a measure of base concentration per unit volume for the sample-extract; and
ix) deriving a measure of base content of the hydrophobic fluid sample based upon the base concentration per unit volume for the sample-extract as derived in viii).

2. A method according to claim 1, further comprising:
x) storing the measure of base content of the hydrophobic fluid sample as derived in ix) for output.

3. A method according to claim 2, further comprising:
xi) outputting to a user the measure of base content of the hydrophobic fluid sample stored in x).

4. A method according to claim 1, wherein:
the measure of base concentration per unit volume of iv) and viii) is defined in mEq base/mL.

5. A method according to claim 1, wherein:
the base content of ix) is defined in mEq base/g of the fluid sample.

6. A method according to claim 1, wherein:
the processing of iv) includes the derivation of differential spectrum data for the number of mixtures of ii), and processing the differential spectrum data for the number of mixtures of ii) to derive final spectrum data for the number of mixtures of ii); and
the processing of vii) includes the derivation of differential spectrum data for the sample-extract, and processing the differential spectrum data for the sample-extract to derive final spectrum data for the sample-extract.

7. A method according to claim 6, wherein:
the differential spectrum data of iv) and vii) are based on a 5-5 (gap-segment) derivative of spectral data.

8. A method according to claim 6, wherein:
the differential spectrum data of iv) and vii) are based on respective correction factors derived from spectral data at or near 1936 cm⁻¹.

9. A method according to claim 8, wherein:
the respective correction factors are further based on spectral data at or near 1859 cm⁻¹.

10. A method according to claim 6, wherein:
in iv), the calibration equation is derived by fitting spectral properties defined by a predetermined wavelength of the final spectrum data for the number of mixtures of ii) to measures of base concentration per unit volume for the number of mixtures of ii);
in vii), a spectral property is defined by the predetermined wavelength of the final spectrum data for the sample-extract; and
in viii), the spectral property defined in vii) is input to the calibration equation derived in iv).

11. A method according to claim 1, wherein:
in iv), the calibration equation is derived by fitting spectral properties relating to a predefined wavelength for the number of mixtures of ii), wherein the predefined wavelength is in the range between 1666 cm⁻¹ and 1686 cm⁻¹ (preferably at or near 1676 cm⁻¹).

12. A method according to claim 1, wherein:
the base of ii) includes 1-methylimidazole.

13. A method according to claim 1, wherein:
the measure of base concentration per unit volume for the sample-extract output in viii) is independent of the volume of the solution of i) in the sample-extract and the weight of the hydrophobic fluid used to prepare the sample-extract.

14. A method according to claim 1, wherein:
the mixtures of ii) and the sample-extract of v) further includes a hydrophobic solvent.

15. A method according to claim 14, wherein:
the hydrophobic solvent comprises heptane.

16. A method according to claim 1, wherein:
the alcohol solvent of the solution of i) is selected from the group including 1-propanol, ethanol, methanol, and combinations thereof

17. A method according to claim 1, wherein:
the solution of i) includes TFA.

18. A method according to claim 1, wherein:
the solution of i) includes a fluorinated, chlorinated or brominated carboxylic acid.

19. A method according to claim 1, wherein:
the measure of base content of the hydrophobic fluid sample is derived in ix) without splitting of the hydrophobic fluid sample.
